(19) United States
(12) Patent Application Publication
(10) Pub. No.: US 2026/0269637 A1
(43) Pub. Date: Sep. 10, 2026

(54) SYSTEM AND METHOD FOR DEACTIVATING BATTERY CELLS

(71) Applicant: Samsung SDI Co., Ltd., Yongin-si (KR)

(72) Inventors: Jake Kim, Yongin-si (KR); Hongbeom Kim, Yongin-si (KR)

(73) Assignee: Samsung SDI Co., Ltd., Yongin-si (KR)

(21) Appl. No.: 19/462,234

(22) Filed: Jan. 28, 2026

(30) Foreign Application Priority Data
Mar. 6, 2025 (KR) 10-2025-0028802

(51) Int. Cl. H02J 7/50; H01M 10/44; H01M 10/613; H01M 10/647; H01M 50/209; H01M 50/51; H02J 7/00

(52) U.S. Cl. CPC H02J 7/585; H01M 10/441; H01M 10/613; H01M 10/647; H01M 50/209; H01M 50/51; H02J 7/855

(57) ABSTRACT

A battery cell deactivation system includes a connection device configured to connect a plurality of battery cells in series, a power supply unit capable of adjusting current or voltage and configured to supply power for discharging the plurality of battery cells connected in series through the connection device, and a controller configured to control the power supply unit to discharge the plurality of battery cells connected in series by adjusting at least one of current and voltage of the power supply unit.

### CROSS-REFERENCE TO RELATED APPLICATIONS

This present application claims priority to and the benefit under 35 U.S.C. § 119(a)-(d) of Korean Patent Application No. 10-2025-0028802, filed on Mar. 6, 2025, in the Korean Intellectual Property Office, the entire disclosure of which is incorporated herein by reference.

### FIELD

The present disclosure relates to a battery cell deactivation system and more particularly to a battery cell deactivation system including a controller that controls a power supply, and to a battery cell deactivation method.

### BACKGROUND

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the electrode assembly, and electrode terminals connected to the electrode assembly.

As demand for secondary batteries (or battery cells) increases, the number of end-of-life secondary batteries (that is, waste batteries) may also increase. Such waste batteries pose risks of fire or explosion due to residual energy remaining inside and therefore need to be disposed of safely. According to the related art, in order to dispose of a waste battery, a thermal resistor is connected to the positive electrode and the negative electrode to discharge the waste battery. In this case, because the discharge operation is performed by processing waste batteries one by one, a large amount of time is required to dispose of many waste batteries.

The herein information disclosed in this Background section is for enhancement of understanding of the background of the present disclosure, and therefore, it may contain information that does not constitute related (or prior) art.

### SUMMARY

The present disclosure provides a battery cell deactivation system and method capable of solving the herein-described technical problem.

These and other aspects and features of the present disclosure will be described in or will be apparent from the following description of embodiments of the present disclosure.

In some embodiments, a battery cell deactivation system includes a connection device configured to connect a plurality of battery cells in series, a power supply unit capable of adjusting current or voltage and configured to supply power for discharging the plurality of battery cells connected in series through the connection device, and a controller configured to control the power supply unit to discharge the plurality of battery cells connected in series by adjusting at least one of current and voltage of the power supply unit.

In some embodiments, the connection device may include a housing configured to receive the plurality of battery cells and a connector disposed on an upper portion of the housing and configured to connect the plurality of battery cells in series.

In some embodiments, the connector may include a first connector configured to connect the power supply unit and at least some of the plurality of battery cells and a plurality of second connectors configured to connect adjacent battery cells among the plurality of battery cells.

In some embodiments, the first connector is connected to the battery cells located at both ends of the plurality of battery cells.

In some embodiments, the plurality of battery cells may include a first battery cell and a second battery cell adjacent to the first battery cell, any one of the plurality of second connectors connects electrode terminals of the first battery cell and the second battery cell, and polarity of the electrode terminal of the first battery cell and polarity of the electrode terminal of the second battery cell differ from one another.

In some embodiments, each of the plurality of battery cells may include a first electrode terminal having a first polarity and a second electrode terminal having a second polarity different from the first polarity, and each of the plurality of second connecting portions may include a first coupler connected to the first electrode terminal, a second coupler connected to the second electrode terminal, and a wire connecting the first coupler and the second coupler

In some embodiments, the first coupler may include a fixing part fixed by being connected to the wire, a contact part configured to contact the first electrode terminal, and an elastic part disposed between the fixing part and the contact part and configured to provide elastic restoring force to the contact part.

In some embodiments, the connection device may further include a support part configured to support the connector from above the accommodating part, one end of the first connector may be connected to at least some of the plurality of battery cells, and another end of the first connector may pass through the support part and is connected to the power supply unit.

In some embodiments, the plurality of battery cells may include a first set of battery cells and a second set of battery cells, the connection device may include a first connection device configured to connect the first set of battery cells in series and a second connection device configured to connect the second set of battery cells in series, and the connector of the first connection device may be connected to the connector of the second connection device.

In some embodiments, the receiving portion may guide the position of each of the plurality of battery cells so that the connector corresponds to the plurality of battery cells.

In some embodiments, the battery cell deactivation system may further include a cooling unit configured to cool the plurality of battery cells.

In some embodiments, the battery cell deactivation system may further include a setting unit configured to set discharge conditions of the plurality of battery cells, wherein the controller controls the plurality of battery cells connected in series to be over-discharged to a voltage minimum point that is a negative voltage based on the discharge conditions.

In some embodiments, the voltage minimum point may be an inflection point at which voltage of the plurality of battery cells connected in series changes from a decrease to an increase during discharge of the plurality of battery cells connected in series.

In some embodiments, based on the discharge conditions, the controller may control the power supply unit to over-discharge the plurality of battery cells connected in series to the voltage minimum point by at least one of constant current or constant voltage.

In some embodiments, the discharge conditions may include a discharge pattern that includes at least one constant-current discharge section or constant-voltage discharge section, a magnitude of discharge current, a discharge time, and a rest time.

In some embodiments, the controller, based on the discharge pattern, may control discharging of the plurality of battery cells connected in series for the discharge time and may control the pausing of the discharge of the plurality of battery cells connected in series for the rest time.

In some embodiments, the controller may discharge the plurality of battery cells connected in series at a first constant current and a first constant voltage for a first discharge time, may pause discharge of the plurality of battery cells connected in series for the rest time, and may discharge the plurality of battery cells connected in series at a second constant current and a second constant voltage for a second discharge time.

In some embodiments, a magnitude of the second constant current may be smaller than a magnitude of the first constant current, a magnitude of the second constant voltage may be greater than a magnitude of the first constant voltage, and the second discharge time may be longer than the first discharge time.

In some embodiments, a battery cell deactivation method may include connecting a plurality of battery cells arranged in one direction in series using a connection device and connecting the plurality of battery cells connected in series to a power supply unit, and discharging the plurality of battery cells by adjusting at least one of current and voltage of the power supply unit, wherein the power supply unit is capable of adjusting current or voltage and is configured to supply power for discharging the plurality of battery cells connected in series through the connection device.

In some embodiments, the battery cell deactivation method may further include setting discharge conditions of the plurality of battery cells connected in series, wherein the discharging may include over-discharging the plurality of battery cells connected in series to a voltage minimum point that is a negative voltage based on the discharge conditions.

According to some embodiments of the present disclosure, without employing a wet deactivation method that disassembles battery cells and removes activity of active materials using brine, activity of battery cells may be electrochemically removed through dry disassembly. In addition, by removing activity by connecting a large number of battery cells in series, a large number of waste batteries may be generated in a short time. Accordingly, a large number of waste batteries may be efficiently obtained in a safe manner.

According to some embodiments of the present disclosure, the plurality of battery cells may be over-discharged using a discharge pattern. According to such a discharge pattern, by providing a rest time in the middle of over-discharging the plurality of battery cells, over-discharge of the plurality of battery cells may be performed in a shorter time, and heat generated from the plurality of battery cells due to over-discharge may be reduced.

However, aspects and features of the present disclosure are not limited to those described herein, and other aspects and features not mentioned will be clearly understood by those skilled in the art from the detailed description herein.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an example of a battery cell deactivation system according to embodiments of the present disclosure.

FIG. 2 illustrates an example in which a connection device according to embodiments of the present disclosure connects a plurality of battery cells in series.

FIG. 3 illustrates an example in which a connection device according to embodiments of the present disclosure connects a plurality of battery cells.

FIG. 4 is a diagram illustrating an example of a second connecting portion according to embodiments of the present disclosure.

FIG. 5 is a diagram illustrating an example of a first coupler according to embodiments of the present disclosure.

FIG. 6 illustrates an example in which a connection device according to embodiments of the present disclosure connects a plurality of battery cells in series.

FIG. 7 illustrates an example of a battery cell deactivation system according to embodiments of the present disclosure.

FIG. 8 illustrates an example of a configuration of a battery cell deactivation system according to embodiments of the present disclosure.

FIG. 9 illustrates an example of voltage and temperature profiles when a battery cell is over-discharged according to embodiments of the present disclosure.

FIG. 10 illustrates an example of voltage and current profiles when a plurality of battery cells is over-discharged according to embodiments of the present disclosure.

FIG. 11 illustrates an example of voltage and current profiles when a plurality of battery cells is over-discharged based on discharge conditions according to embodiments of the present disclosure.

FIG. 12 is a flowchart illustrating an example of a battery cell deactivation method according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her disclosure in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to one another, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, sizes and relative sizes of layers and regions shown in the drawings may be exaggerated for clarity of explanation. In other words, sizes shown in the drawings are for convenience of understanding only and are not limited thereto. Throughout the specification, identical reference numerals designate identical components.

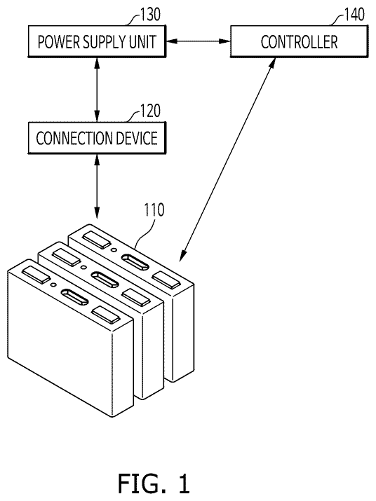

FIG. 1 illustrates an example of a battery cell deactivation system according to embodiments of the present disclosure.

In embodiments, the battery cell deactivation system may include: a plurality of battery cells 110; a connection device 120 configured to connect the plurality of battery cells 110 in series; a power supply unit 130 capable of adjusting current or voltage and configured to supply power for discharging the plurality of battery cells 110 connected in series through the connection device 120; and a controller 140 configured to control the power supply unit 130 to discharge the plurality of battery cells 110 connected in series. Here, the power supply unit 130 may include a power source and a discharge circuit in which a resistor is connected in series, but a configuration of the power supply unit 130 is not limited thereto. The controller 140 may receive information associated with the plurality of battery cells 110 (for example, current, voltage, temperature of respective ones of the plurality of battery cells 110) from the plurality of battery cells 110.

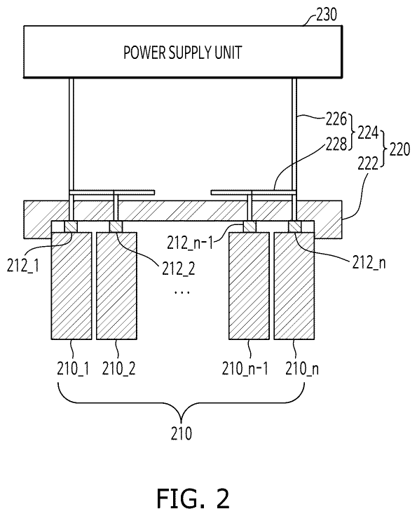

In one embodiment, the connection device 120 may include a receiving portion that accommodates the plurality of battery cells 110 and a connector that connects the plurality of battery cells 110 in series. The connector may penetrate through the top of and be coupled to the receiving portion. By virtue of the connection device 120 that includes this configuration and connects the plurality of battery cells 110 in series, the controller 140 and the power supply unit 130 may discharge the plurality of battery cells 110 simultaneously through the connection device 120. Examples of the connection device 120 are described in detail herein with reference to FIGS. 2 to 6.

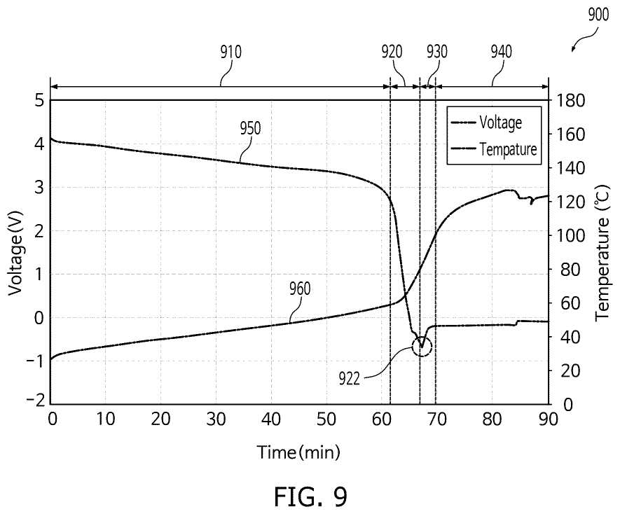

In embodiments, the controller 140 may discharge the plurality of battery cells 110 by adjusting at least one of the current and voltage of the power supply unit 130. Specifically, the controller 140 may control the power supply unit 130 to over-discharge the plurality of battery cells 110 connected in series to a minimum voltage that is negative based on discharge conditions. Examples of over-discharging the plurality of battery cells 110 are described in detail herein with reference to FIGS. 9 to 11.

In embodiments, by over-discharging the plurality of battery cells 110, positive electrodes and negative electrodes of respective ones of the plurality of battery cells 110 may be electrochemically dismantled. That is, metals included in the positive electrodes and the negative electrodes may be leached and recovered through over-discharging the plurality of battery cells 110. In addition, through over-discharging the plurality of battery cells 110, a lithium compound present in the form of a solid electrolyte interphase layer on a surface of a negative-electrode active material may be removed while copper, which is a negative-electrode substrate, is leached, and hence activity of the plurality of battery cells 110 may be removed. Accordingly, a plurality of safe waste batteries that are deactivated may be generated.

With this configuration, activity of battery cells may be electrochemically removed through dry dismantling without employing a wet deactivation method that dismantles battery cells and removes activity of active materials using brine. In addition, by removing activity by connecting a large number of battery cells in series, a large number of waste batteries may be generated in a short time. Accordingly, a large number of waste batteries may be efficiently obtained in a safe manner.

FIG. 2 illustrates an example in which a connection device 220 connects a plurality of battery cells 210 in series according to embodiments of the present disclosure.

In embodiments, the connection device 220 may include a receiving portion 222 that receives the plurality of battery cells 210, and a connector 224 that connects the plurality of battery cells 210 in series. Here, the receiving portion 222 may be disposed above the plurality of battery cells 210. In addition, the receiving portion 222 may guide the positions of respective ones of the plurality of battery cells 210 so that each connection terminal of the connector 224 corresponds to each electrode terminal of the respective plurality of battery cells 210.

In embodiments, the connector 224 may include a first connector 226 configured to connect at least some of the plurality of battery cells 210 and the power supply unit 230 and a plurality of second connectors 228 configured to connect adjacent battery cells among the plurality of battery cells 210. Here, the first connector 226 may be connected to battery cells located at both ends among the plurality of battery cells 210 arranged in one direction. For example, the first connector 226 may be connected to a first battery cell 210_1 and an n-th battery cell 210_n located at both ends among the plurality of battery cells 210. The first connector 226 may be connected to a first electrode terminal of the first battery cell 210_1 and a second electrode terminal (that is, the electrode terminal having a polarity opposite to that of the first electrode terminal) of the n-th battery cell 210_n among electrode terminals of the plurality of battery cells 210.

In embodiments, each of the plurality of second connectors 228 may electrically connect adjacent battery cells. Specifically, each of the plurality of second connectors 228 may connect electrode terminals 212_1 to 212_n of adjacent battery cells. For example, any one of the plurality of second connectors 228 may connect an electrode terminal 212_1 of the first battery cell 210_1 and an electrode terminal 212_2 of a second battery cell 210_2. In this case, the polarity of the electrode terminal 212_1 of the first battery cell 210_1 and the polarity of the electrode terminal 212_2 of the second battery cell 210_2 may differ from one another. Accordingly, the plurality of second connectors 228 may connect the plurality of battery cells 210 in series.

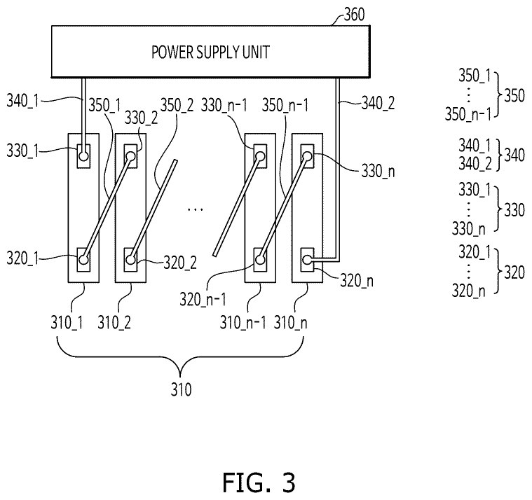

FIG. 3 illustrates an example in which a connection device connects a plurality of battery cells 310 according to embodiments of the present disclosure.

In embodiments, the connection device may include a receptacle suitable for receiving the plurality of battery cells 310 and a connector that connects the plurality of battery cells 310 in series. Here, the connector may include a first connector 340 that connects the power supply unit 360 and at least some of the plurality of battery cells 310, and a plurality of second connectors 350 that connect adjacent battery cells among the plurality of battery cells 310. The first connector 340 may be connected to battery cells located at both ends among the plurality of battery cells 310 aligned in one direction. For example, among the first connector 340, a first-1 connector 340_1 may be connected to a first battery cell 310_1 located at one end among the plurality of battery cells 310, and a first-2 connector 340_2 among the first connector 340 may be connected to an n-th battery cell 310_n located at the other end among the plurality of battery cells 310.

In embodiments, each of the plurality of battery cells 310 may include a first electrode terminal 320 having a first polarity and a second electrode terminal 330 having a second polarity different from the first polarity. In this case, the polarity of an electrode terminal of the first battery cell 310_1 connected to the first-1 connection part 340_1 and the polarity of an electrode terminal of the n-th battery cell 310_n connected to the first-2 connection part 340_2 may differ from one another. For example, the first-1 connection part 340_1 may be connected to the second electrode terminal 330_1 of the first battery cell 310_1, and the first-2 connection part 340_2 may be connected to the first electrode terminal 320_n of the n-th battery cell 310_n.

In embodiments, the plurality of second connectors 350 may electrically connect adjacent battery cells. Specifically, each of the plurality of second connectors 350 may connect electrode terminals of adjacent battery cells. In this case, each of the plurality of second connectors 350 may connect electrode terminals having different polarities of adjacent battery cells.

For example, the (2_1)-th connector 350_1 may connect the first electrode terminal 320_1 of the first battery cell 310_1 and the second electrode terminal 330_2 of the second battery cell 310_2 adjacent to the first battery cell 310_1. Similarly, the (2_n-1)-th connector 350_n-1 may connect the first electrode terminal 320_n-1 of the (n-1)-th battery cell 310_n-1 and the second electrode terminal 330_n of the n-th battery cell 310_n adjacent to the (n-1)-th battery cell 310_n-1. As shown in FIG. 3, to connect electrode terminals having different polarities, each of the plurality of second connectors 350 may be obliquely arranged above the plurality of battery cells 310 arranged in one direction.

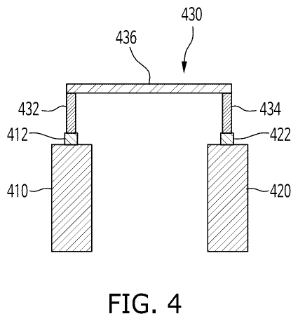

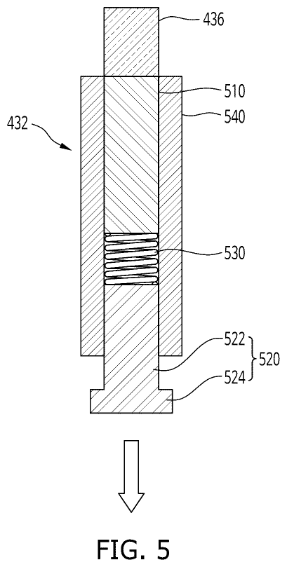

FIG. 4 is a diagram illustrating an example of a second connector 430 according to embodiments of the present disclosure, and FIG. 5 is a diagram illustrating an example of a first coupler 432 according to embodiments of the present disclosure.

In embodiments, referring to FIG. 4, the second connecting part 430 (for example, 350 in FIG. 3) may include a first connector 432 connected to an electrode terminal 412 of a first battery cell 410, a second connector 434 connected to an electrode terminal 422 of a second battery cell 420, and a wire 436 connecting the first connector 432 and the second connector 434. Here, the first battery cell 410 and the second battery cell 420 may be arranged in one direction at a constant interval and may be adjacent to one another. In addition, the polarity of the electrode terminal 412 of the first battery cell 410 may differ from the polarity of the electrode terminal 422 of the second battery cell 420.

In embodiments, referring to FIG. 5, the first connector 432 may include: a fixing part 510 fixed and connected to the wire 436, a contact part 520 in contact with the electrode terminal 412 of the first battery cell 410; an elastic part 530 disposed between the fixing part 510 and the contact part 520 and providing an elastic restoring force to the contact part 520; and a housing 540 configured to protect the fixing part 510, the elastic part 530, and the contact part 520. Here, the fixing part 510, the contact part 520, and the elastic part 530 may be produced from a conductive material (for example, a metal material such as copper or aluminum) and may be electrically connected to one another. Additionally, the contact part 520 may contact the electrode terminal 412 by being lowered through the elastic restoring force provided by the elastic part 530. For example, the elastic part 530 may include a compression spring, but is not limited thereto.

In embodiments, the contact part 520 may include a protrusion 522 connected to the elastic part 530 and a head 524 connected to the protrusion 522 and configured to contact the electrode terminal 412. Here, a diameter of the head 524 may be greater than a diameter of the protrusion 522. In addition, the housing 540 may surround outer sides of the fixing part 510, the elastic part 530, and the protrusion 522.

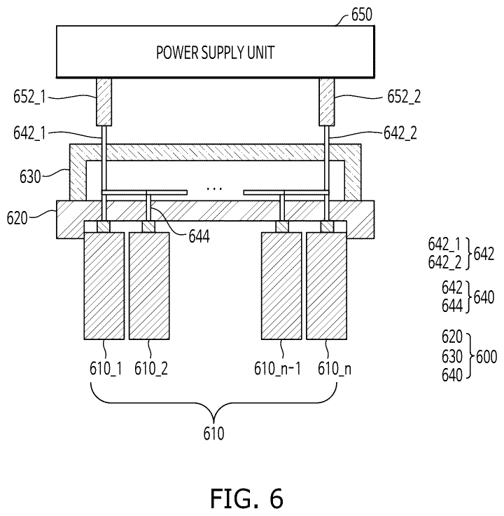

FIG. 6 illustrates an example in which a connection device 600 connects a plurality of battery cells 610 in series according to embodiments of the present disclosure.

In one embodiment, the connection device 600 may include a receiving part 620 that accommodates a plurality of battery cells 610, a connecting part 640 that connects the plurality of battery cells 610 in series, and a supporting part 630 that supports the connecting part 640 on top of the receiving part 620. Here, the receiving part 620 can be arranged on top of the plurality of battery cells 610. Moreover, the receiving part 620 can guide the position of each of the plurality of battery cells 610 so that each connection terminal of the connecting part 640 corresponds with the electrode terminal of each of the plurality of battery cells 610.

In embodiments, the connector 640 may include a first connector 642 that connects the power supply unit 650 and at least some of the plurality of battery cells 610, and a plurality of second connectors 644 that connect adjacent battery cells among the plurality of battery cells 610. Here, the first connector 642 may be connected to battery cells located at both ends among the plurality of battery cells 610 arranged in one direction. For example, the first connector 642 may be connected to a first battery cell 610_1 and an n-th battery cell 610_n located at both ends among the plurality of battery cells 610.

In embodiments, one end of the first connector 642 may pass through the housing 620 and be connected to at least some of the plurality of battery cells 610. In addition, another end of the first connector 642 may pass through the support part 630 and be connected to the power supply unit 650. For example, one end of a first-1 connector 642_1 may be connected to the first battery cell 610_1, and another end of the first-1 connector 642_1 may be connected to a first connection part 652_1 of the power supply unit 650. Similarly, one end of a first-2 connector 642_2 may be connected to the n-th battery cell 610_n, and another end of the first-2 connector 642_2 may be connected to a second connection part 652_2 of the power supply unit 650. In this case, while protecting the connector 640, the support part 630 may support the first connector 642 so that the first connector 642 is connected to the power supply unit 650. The support part 630 may include an insulating material to prevent a short circuit but is not limited thereto.

In embodiments, respective ones of the plurality of second connectors 644 may electrically connect adjacent battery cells. Specifically, each of the plurality of second connectors 644 may connect electrode terminals of adjacent battery cells. Accordingly, by virtue of the plurality of second connectors 644, the plurality of battery cells 610 may be connected in series, and the power supply unit 650 and the plurality of battery cells 610 may be electrically connected through the connection device 600.

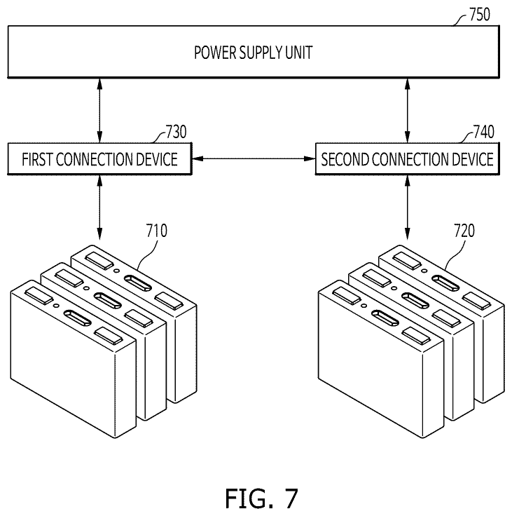

FIG. 7 illustrates an example of a battery cell deactivation system according to embodiments of the present disclosure.

In embodiments, the battery cell deactivation system may discharge a plurality of battery cells using a plurality of connection devices and a power supply unit 750. Here, the plurality of battery cells may include a first set of battery cells 710 and a second set of battery cells 720. The first set of battery cells 710 and the second set of battery cells 720 may be arranged in parallel, but an arrangement manner is not limited thereto.

In embodiments, the plurality of connection devices may include a first connection device 730 configured to connect the first set of battery cells 710 in series and a second connection device 740 configured to connect the second set of battery cells 720 in series. Here, each of the first connection device 730 and the second connection device 740 may include a receiving part that accommodates a plurality of battery cells and a connection part that connects the plurality of battery cells in series. In this case, the connection part of the first connection device 730 may be connected to the connection part of the second connection device 740. Accordingly, the first set of battery cells 710 and the second set of battery cells 720 may be connected in series.

In embodiments, the first connection device 730 and the second connection device 740 may be connected to the power supply unit 750. Accordingly, the battery cell deactivation system may discharge the first set of battery cells 710 and the second set of battery cells 720 connected in series through the first connection device 730 and the second connection device 740 simultaneously.

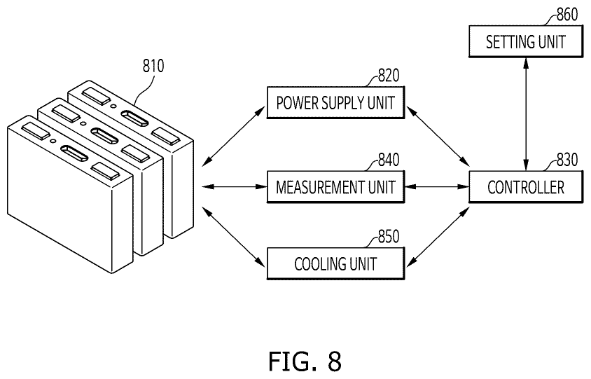

FIG. 8 illustrates an example of a configuration of a battery cell deactivation system according to embodiments of the present disclosure.

In embodiments, the battery cell deactivation system may include: a plurality of battery cells 810; a connection device (not shown) configured to connect the plurality of battery cells 810 in series; a power supply unit 820 capable of adjusting current or voltage and configured to supply power for discharging the plurality of battery cells 810 connected in series through the connection device; and a controller 830 configured to control the power supply unit 820 to discharge the plurality of battery cells 810 connected in series. Here, the power supply unit 820 may refer to a discharge circuit in which a power source and a resistor connected in series are included, but the configuration of the power supply unit 820 is not limited thereto.

In embodiments, the battery cell deactivation system may further include a measurement unit 840 that measures data such as temperature, voltage, and current of the plurality of battery cells 810 using sensors such as a temperature sensor, a voltage sensor, and a current sensor. The measurement unit 840 may transmit the measured data to the controller 830. Additionally, the measurement unit 840 may visualize the measured data in a graph and output the graph on a display of the deactivation system.

In embodiments, the battery cell deactivation system may further include a cooling unit 850 configured to cool the plurality of battery cells 810. Here, the cooling unit 850 may be connected to the plurality of battery cells 810. The cooling unit 850 may include at least one of a heat-dissipating pad, a heat pump, a heat-dissipation fin, a fan, and a cooling-water convection device. In this case, the controller 830 may control the cooling unit 850 so as to cool the plurality of battery cells 810 based on heat-generation temperatures of the plurality of battery cells 810 measured by the measurement unit 840.

In embodiments, the battery cell deactivation system may further include a setting unit 860 configured to set discharge conditions of the plurality of battery cells 810. Here, the discharge conditions may include at least one of a discharge pattern that includes at least one constant-current discharge section or constant-voltage discharge section, a magnitude of discharge current, a discharge time, a rest time, a discharge target potential or a discharge target state of charge (SoC). Such discharge conditions may be received from a user (or a user terminal) or may be predetermined and stored according to a type or model of a battery cell. Additionally or alternatively, the discharge conditions may be set and changed in real time based on residual energy (including current and/or voltage) and heat-generation temperature of the plurality of battery cells 810 measured by the measurement unit 840.

In embodiments, the controller 830 may control a plurality of battery cells 810 connected in series to be discharged to a voltage minimum point that is a negative voltage based on discharge conditions. Here, the voltage minimum point may refer to an inflection point at which voltage of the plurality of battery cells 810 changes from a decrease to an increase during discharge of a plurality of battery cells 810 connected in series. Examples in which the plurality of battery cells 810 are discharged are described in detail herein with reference to FIGS. 9 to 11.

FIG. 9 illustrates an example of a voltage and temperature profile 900 when a battery cell is over-discharged according to embodiments of the present disclosure. The illustrated voltage and temperature profile 900 shows changes in voltage 950 and temperature 960 when a prismatic battery cell having a charging capacity of 37 Ah is continuously discharged at a constant current of 1 C. A first section 910 represents a section in which the battery cell is generally used. Here, the battery cell may have a voltage of about 4.1 V to 2.7 V.

By discharging the battery cell, voltage of the battery cell may decrease. A second section 920 represents a section in which the battery cell is discharged to the voltage minimum point 922. Here, voltage of the battery cell may drastically decrease to the voltage minimum point (about −1.0 V). Voltage of the battery cell converges to 0 V as an electromotive-force difference between the positive electrode and the negative electrode gradually decreases, but voltage of the battery cell may become negative because internal resistance of the battery cell gradually increases. In addition, the voltage minimum point may have different negative voltage values depending on a positive-electrode active material or a negative-electrode active material included in the battery cell.

In one embodiment, around the voltage extremum point (922), the metal contained in the anode or cathode of the battery cell might be leached. The third section (930) represents a phase where the metal is leached. In this interval, in the anode and cathode active materials, lithium intercalation and deintercalation reactions almost do not occur, while the copper (Cu) serving as the anode substrate may be leached. As the leached copper ions precipitate, an internal short circuit between the anode and cathode of the battery cell might occur. Consequently, the applied current to the battery cell might directly traverse the anode and cathode, thereby potentially reducing the battery cell's internal resistance. In such scenarios, the battery cell's voltage can rise to approximately 0 V.

Through over-discharge, residual energy of the battery cell may be leaked. A fourth section 940 represents a section in which the current applied to the battery cell is leaked due to the internal short circuit formed by the leached copper. In this section, since activity of the battery cell is removed, power supply to the battery cell may be blocked. Accordingly, a waste battery may be prepared in a deactivated state.

As the battery cell is used and discharged, temperature of the battery cell may continuously increase. Particularly, in the second section 920 and the third section 930, temperature of the battery cell may drastically increase, and safety of the waste battery may be impaired. In order to obtain a safer waste battery, heat generated from the battery cell may be reduced by connecting a heat-dissipation device to the battery cell or by causing the battery cell to over-discharge using a predetermined discharge pattern.

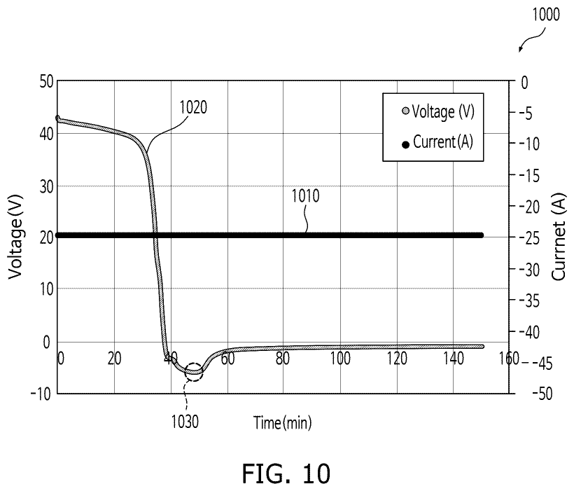

FIG. 10 is a diagram illustrating an example of a voltage and current profile 1000 in the case of over-discharging a plurality of battery cells according to embodiments of the present disclosure.

In embodiments, the illustrated voltage and current profile 1000 is an example showing the changes in voltage 1020 and current 1010 when twelve battery cells connected in series are continuously discharged at a constant current (for example, 24 A). Similar to what was described with reference to FIG. 9, in the case of the plurality of battery cells, the plurality of battery cells may also be discharged to the voltage minimum point 1030. Subsequently, the voltage 1020 of the plurality of battery cells converges to 0 V as the electromotive force difference between the positive electrode and the negative electrode becomes increasingly smaller after reaching the voltage minimum point 1030. However, the voltage may become negative because the internal resistance of the battery cells gradually increases. Therefore, even when the plurality of battery cells is over-discharged in series, the activity of each of the plurality of battery cells can be electrochemically removed.

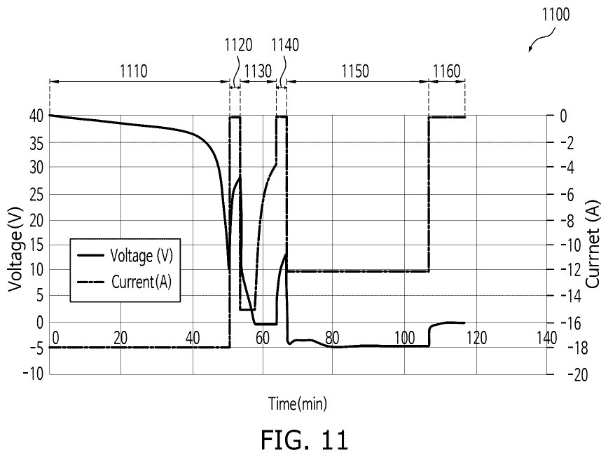

FIG. 11 illustrates an example of a voltage and current profile 1100 when a plurality of battery cells is over-discharged based on discharge conditions according to one embodiment of the present disclosure.

In one embodiment, the controller (for example, 830 in FIG. 8) may control the power supply unit (for example, 820 in FIG. 8) to over-discharge the plurality of battery cells connected in series to a voltage minimum point that is a negative voltage (about −4 V to −5 V) based on discharge conditions. Here, the voltage minimum point may signify an inflection point where the voltage of the plurality of battery cells connected in series transitions from a decrease to an increase during their discharge. Moreover, based on the discharge conditions, the controller may control the power supply unit to over-discharge the plurality of battery cells connected in series to the voltage minimum point under at least one of constant current or constant voltage.

In embodiments, the discharge conditions may include a discharge pattern that includes at least one constant-current discharge section or constant-voltage discharge section, the magnitude of discharge current, a discharge time, and a rest time. In this case, based on the discharge pattern, the controller may discharge the plurality of battery cells connected in series for the discharge time. In addition, the controller may control discharge of the plurality of battery cells connected in series to be paused for the rest time.

In embodiments, the controller may discharge the plurality of battery cells in multiple stages. Specifically, the controller may discharge the plurality of battery cells connected in series at a first constant current and a first constant voltage for a first discharge time. In addition, the controller may pause discharge of the plurality of battery cells connected in series for the rest time. Thereafter, the controller may control the plurality of battery cells connected in series to be discharged at a second constant current and a second constant voltage for a second discharge time. Here, a magnitude of the second constant current may be smaller than a magnitude of the first constant current, a magnitude of the second constant voltage may be greater than a magnitude of the first constant voltage, and the second discharge time may be longer than the first discharge time.

Referring to FIG. 11, the voltage and current profile 1100 is an example showing changes in voltage and current of the plurality of battery cells when twelve battery cells connected in series are discharged in multiple stages using the battery cell deactivation system. In a first section 1110, the plurality of battery cells may be discharged at a constant current (for example, 18 A) for 10 minutes. Thereafter, in a second section 1120, discharge of the plurality of battery cells may be paused. In a third section 1130, the plurality of battery cells may be discharged in a constant-current-constant-voltage manner (that is, CCCV discharge) at a constant current (15 A) and a constant voltage (−0.6 V) for 10 minutes. Thereafter, in a fourth section 1140, discharge of the plurality of battery cells may be paused. In a fifth section 1150, the plurality of battery cells may be discharged in a CCCV manner at a constant current (12 A) and a constant voltage (−18 V) for 40 minutes. Thereafter, in a sixth section 1160, discharge of the plurality of battery cells may be paused. As described herein, by repeating discharging the plurality of battery cells for the discharge time and pausing discharge for the rest time, the battery cell deactivation system may over-discharge the plurality of battery cells to the voltage minimum point.

In FIG. 11, over-discharge of the plurality of battery cells is described using a discharge pattern that includes constant-current (CC) discharge sections, constant-current-constant-voltage (CC-CV) discharge sections, discharge times, and rest times, but the present disclosure is not limited thereto. For example, in order to control heat-generation temperatures of the plurality of battery cells within a range in which safety issues do not occur, the plurality of battery cells may be over-discharged using various discharge patterns such as multi-stage constant-current (CC) discharge including a rest stage, multi-stage constant-voltage (CV) discharge including a rest stage, and multi-stage constant-current-constant-voltage (CC-CV) discharge including a rest stage.

With this configuration, the plurality of battery cells may be over-discharged using the discharge pattern. According to such a discharge pattern, by providing a rest time in the middle of over-discharging the plurality of battery cells, over-discharge of the plurality of battery cells may be performed in a shorter time, and heat generated from the plurality of battery cells due to over-discharge may be reduced.

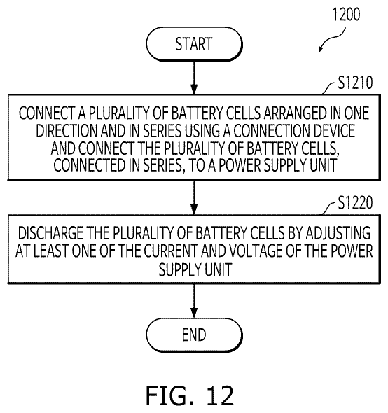

FIG. 12 is a flowchart illustrating an example of a battery cell deactivation method 1200 according to embodiments of the present disclosure. In embodiments, the battery cell deactivation method 1200 may begin with connecting a plurality of battery cells arranged in one direction and in series using a connection device and connecting the plurality of battery cells, connected in series, to a power supply unit (S1210). Here, the power supply unit is capable of adjusting current or voltage and configured to supply power for discharging the plurality of battery cells connected in series through the connection device.

Thereafter, the plurality of battery cells may be discharged by adjusting at least one of the current and voltage of the power supply unit (S1220). In this case, discharge conditions of the plurality of battery cells connected in series may be preset. Based on the discharge conditions, the plurality of battery cells connected in series may be over-discharged to the minimum voltage point, which is a negative voltage. Here, the minimum voltage point may be an inflection point at which voltage of the plurality of battery cells connected in series changes from a decrease to an increase during discharge.

Based on the discharge conditions, the plurality of battery cells connected in series may be over-discharged at least one of constant current and constant voltage to the voltage minimum point. Here, the discharge conditions may include a discharge pattern that includes at least one constant-current discharge section or constant-voltage discharge section, a magnitude of discharge current, a discharge time, and a rest time.

Although the present disclosure has been described herein with respect to embodiments thereof, the present disclosure is not limited thereto. Various modifications and variations can be made by those skilled in the art within the spirit of the present disclosure and the equivalent scope of the appended claims.

What is claimed is:

1. A battery cell deactivation system comprising:
a connection device configured to connect a plurality of battery cells in series;
a power supply unit capable of adjusting current or voltage and configured to supply power for discharging the plurality of battery cells connected in series through the connection device; and
a controller configured to control the power supply unit to discharge the plurality of battery cells connected in series by adjusting at least one of current and voltage of the power supply unit.

2. The battery cell deactivation system as claimed in claim 1, wherein the connection device comprises:
a housing configured to receive the plurality of battery cells; and
a connector disposed on an upper portion of the housing and configured to connect the plurality of battery cells in series.

3. The battery cell deactivation system as claimed in claim 2, wherein the connector comprises:
a first connector configured to connect the power supply unit and at least some of the plurality of battery cells; and
a plurality of second connectors configured to connect adjacent battery cells among the plurality of battery cells.

4. The battery cell deactivation system as claimed in claim 3, wherein the first connector is connected to the battery cells located at both ends of the plurality of battery cells.

5. The battery cell deactivation system as claimed in claim 3, wherein the plurality of battery cells comprises a first battery cell and a second battery cell adjacent to the first battery cell,
any one of the plurality of second connectors connects electrode terminals of the first battery cell and the second battery cell, and
polarity of the electrode terminal of the first battery cell and polarity of the electrode terminal of the second battery cell differ from one another.

6. The battery cell deactivation system as claimed in claim 3, wherein each of the plurality of battery cells comprises:
a first electrode terminal having a first polarity; and
a second electrode terminal having a second polarity different from the first polarity, and
wherein each of the plurality of second connecting portions comprises:
a first coupler connected to the first electrode terminal;
a second coupler connected to the second electrode terminal; and
a wire connecting the first coupler and the second coupler

7. The battery cell deactivation system as claimed in claim 6, wherein the first coupler comprises:
a fixing part fixed by being connected to the wire;
a contact part configured to contact the first electrode terminal; and
an elastic part disposed between the fixing part and the contact part and configured to provide elastic restoring force to the contact part.

8. The battery cell deactivation system as claimed in claim 3, wherein the connection device further comprises a support part configured to support the connector from above the accommodating part, and
wherein one end of the first connector is connected to at least some of the plurality of battery cells, and another end of the first connector passes through the support part and is connected to the power supply unit.

9. The battery cell deactivation system as claimed in claim 2, wherein the plurality of battery cells comprises a first set of battery cells and a second set of battery cells,
wherein the connection device comprises:
a first connection device configured to connect the first set of battery cells in series; and
a second connection device configured to connect the second set of battery cells in series, and
wherein the connector of the first connection device is connected to the connector of the second connection device.

10. The battery cell deactivation system as claimed in claim 2, wherein the receiving portion guides the position of each of the plurality of battery cells so that the connector corresponds to the plurality of battery cells.

11. The battery cell deactivation system as claimed in claim 1, further comprising a cooling unit configured to cool the plurality of battery cells.

12. The battery cell deactivation system as claimed in claim 1, further comprising a setting unit configured to set discharge conditions of the plurality of battery cells,
wherein the controller controls the plurality of battery cells connected in series to be over-discharged to a voltage minimum point that is a negative voltage based on the discharge conditions.

13. The battery cell deactivation system as claimed in claim 12, wherein the voltage minimum point is an inflection point at which voltage of the plurality of battery cells connected in series changes from a decrease to an increase during discharge of the plurality of battery cells connected in series.

14. The battery cell deactivation system as claimed in claim 12, wherein, based on the discharge conditions, the controller controls the power supply unit to over-discharge the plurality of battery cells connected in series to the voltage minimum point by at least one of constant current or constant voltage.

15. The battery cell deactivation system as claimed in claim 12, wherein the discharge conditions comprise a discharge pattern that includes at least one constant-current discharge section or constant-voltage discharge section, a magnitude of discharge current, a discharge time, and a rest time.

16. The battery cell deactivation system as claimed in claim 15, wherein the controller, based on the discharge pattern, controls discharging of the plurality of battery cells connected in series for the discharge time, and controls the pausing of the discharge of the plurality of battery cells connected in series for the rest time.

17. The battery cell deactivation system as claimed in claim 15, wherein the controller discharges the plurality of battery cells connected in series at a first constant current and a first constant voltage for a first discharge time, pauses discharge of the plurality of battery cells connected in series for the rest time, and discharges the plurality of battery cells connected in series at a second constant current and a second constant voltage for a second discharge time.

18. The battery cell deactivation system as claimed in claim 17, wherein a magnitude of the second constant current is less than a magnitude of the first constant current, a magnitude of the second constant voltage is greater than a magnitude of the first constant voltage, and the second discharge time is longer than the first discharge time.

19. A battery cell deactivation method comprising:
connecting a plurality of battery cells arranged in one direction in series using a connection device and connecting the plurality of battery cells connected in series to a power supply unit; and
discharging the plurality of battery cells by adjusting at least one of current and voltage of the power supply unit,
wherein the power supply unit is capable of adjusting current or voltage and is configured to supply power for discharging the plurality of battery cells connected in series through the connection device.

20. The battery cell deactivation method as claimed in claim 19, further comprising setting discharge conditions of the plurality of battery cells connected in series,
wherein the discharging comprises over-discharging the plurality of battery cells connected in series to a voltage minimum point that is a negative voltage based on the discharge conditions.
